(19) United States
(12) Patent Application Publication
(10) Pub. No.: US 2011/0002723 A1
(43) Pub. Date: Jan. 6, 2011

(54) METHOD AND DEVICE FOR DISCRIMINATING LIGHT-SCRIBE DISC

(76) Inventors: Yi-Long Hsiao, Taoyuan County (TW); I-Bing Su, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/825,318

(22) Filed: Jun. 28, 2010

(30) Foreign Application Priority Data
Jul. 2, 2009 (TW) 098122536

(51) Int. Cl. B41J 11/44

(52) U.S. Cl. 400/76

(57) ABSTRACT

A method for discriminating a light-scribe disc includes reading the media ID of the disc, comparing the read media ID with media IDs on a table by the bit searching method, discriminating the media ID with the same bit form from the table, setting the operating parameters of the media ID as the operating parameters of printing label, and waiting for a command to print the label to enhance efficiency.

### BACKGROUND OF THE INVENTION

1. Field of the Invention

The present invention relates to a method of discriminating a light-scribe disc and an apparatus thereof, and more particularly, to a method of discriminating a media ID of a control feature zone and an apparatus thereof.

2. Description of the Prior Art

A typical light-scribe disc is formed by putting a layer of paint on a label side of the disc, and utilizing a laser beam from a pickup head to focus on the label side such that the heat will cause changes on the label side to form a label pattern. This allows printing of a figure desired by a user onto the label side directly, generating an artistic and customized optical disc.

This is shown in FIG. 1, which is a conventional light-scribe disc 1. Since there are differences between fabricating companies, processes and materials of the light-scribe disc 1, the characteristic of each scribed label also differs; therefore, a control feature zone 3 is arranged at an inner ring of a label side 2 of the light-scribe disc 1. The inner edge contains four hundred spokes 4 which are allocated by angle, and the outer edge contains marks 5 of a saw-tooth shape, block shape or stripe shape for providing related information such as radial calibration pattern, media IDs and index marks for the light-scribe disc 1. Some setting parameters (for example: the maximum and minimum laser power setting parameters suitable for the light-scribe disc 1, labeling speed and chemical characteristic of the disc) can be looked up in the disc parameter table, which is tested and stored in advance via the media ID, therefore enabling printing of accurate label patterns on the label side 2.

This is shown in FIG. 2, which is a conventional apparatus for identifying a media ID of a light-scribe disc. When starting printing the label pattern of the light-scribe disc 1, the label side 2 is placed facing a pickup head 7 of an optical disc drive 6. In a next step, the optical disc drive 6 checks whether the label side 2 of the light-scribe disc 1 is capable of being imprinted. If the light-scribe disc 1 cannot be imprinted, a microprocessor 8 informs a host 9, the central processing unit (CPU) 10 inside the host 9 then indicates that the label printing fails, and the label printing process ends. If the light-scribe disc 1 can be imprinted, the microprocessor 8 controls the pickup head 7 to read marks of the media ID in the control feature zone 3. The microprocessor 8 informs the CPU 10 to read information of the media ID, and the CPU 10 controls an error correction apparatus 11 to perform error correction function to derive the media ID.

In the next step, the CPU 10 controls a comparing device 12 to check whether the media ID exists in the table of a data base 13 stored in the host 9. If the media ID does not exist in the table, the CPU 10 indicates that the label printing fails and ends the label printing process. If the media ID does exist in the table, the CPU 10 controls to transmit the parameters corresponding to the media ID in the table of the data base 13 to the optical disc drive 6, and the microprocessor 8 stores the parameters in a storage device 14 and sets the parameters as label printing operation parameters of the optical disc drive 6. The process then waits for instructions of printing labels from a user.

The marks 5 in the control feature zone 3 are often damaged due to smears, finger prints or scratches, leading to difficulties in reading media IDs correctly. The prior art does not print labels for those media IDs which are not in the table or unable to be error-corrected; therefore, not only can pattern printing not be performed for a light-scribe disc, but also the light-scribe disc is wasted. Therefore, there are still problems to be solved in identifying media IDs of light-scribe discs.

### SUMMARY OF THE INVENTION

One objective of the present invention is to provide a method of discriminating a light-scribe disc by searching for a media ID quickly via comparing bits of the read media ID, to therefore enhance the discrimination efficiency.

Another objective of the present invention is to provide a method of discriminating a light-scribe disc by utilizing the most similar media ID derived from comparison to exploit and set label printing operation parameters, so damaged light-scribe discs can be spared.

Another objective of the present invention is to provide an apparatus of light-scribe disk discrimination by reading and discriminating media ID directly and simplify apparatus of identifying to increase the flexibility of optical disc drive arrangement.

In order to achieve the aforementioned objectives, the steps of a method according to an exemplary embodiment comprise: reading a media ID of a light-scribe disc; comparing bits of the read media ID and bits of media IDs in a table; utilizing and setting operation parameters corresponding to the media ID in the table, which is identified having identical bits as the read media ID; and waiting for an instruction for printing a label to facilitate label printing.

The steps of a method according to another exemplary embodiment comprise: following an instruction to print a label; utilizing a host to transmit a table of media IDs and corresponding operation parameters; reading a media ID of a light-scribe disc; comparing bits of the read media ID and bits of media IDs in a table and recording an error quantity of bit comparison; choosing the most similar media ID having a minimum error quantity to be utilized as an identified media ID; exploiting and setting operation parameters as operation parameters for printing a label; and waiting for an instruction for printing a label to facilitate label printing.

A light-scribe disc discriminating apparatus according to an embodiment of the present invention is also disclosed, wherein a connected host sets a data base to store and transmit a table of media IDs and corresponding operation parameters into a storage device. A microprocessor controls a pickup head to read a media ID of a label side of a light-scribe disc. A comparing device utilizes the table of media IDs to compare and identify the read media ID by a bit searching method. After the read media ID of the light-scribe disc is confirmed, the microprocessor sets the operation parameters stored in the table in the storage device, which corresponds to the identified media ID, to be utilized as operation parameters for label printing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structure diagram of a conventional light-scribe disc.

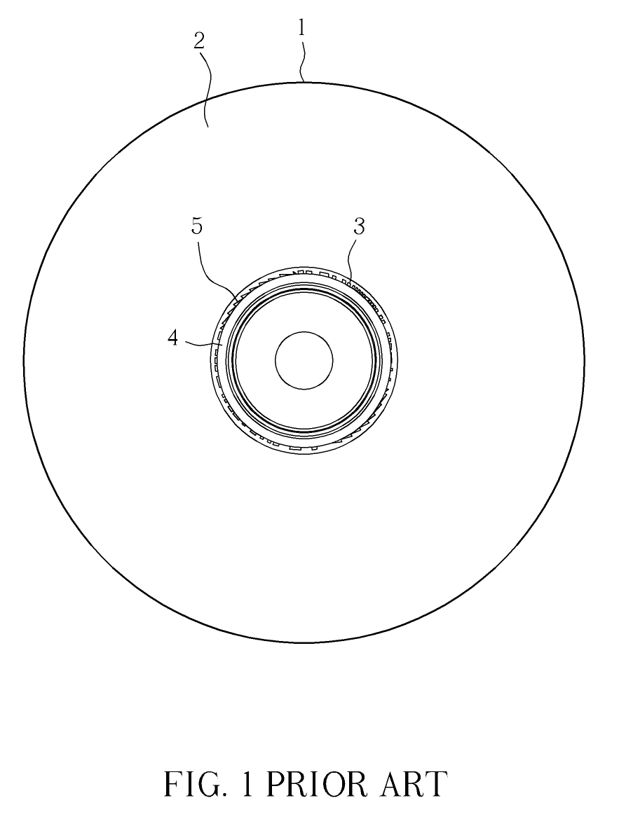

FIG. 2 is a functional block diagram of a conventional apparatus for identifying a media ID of a light-scribe disc.

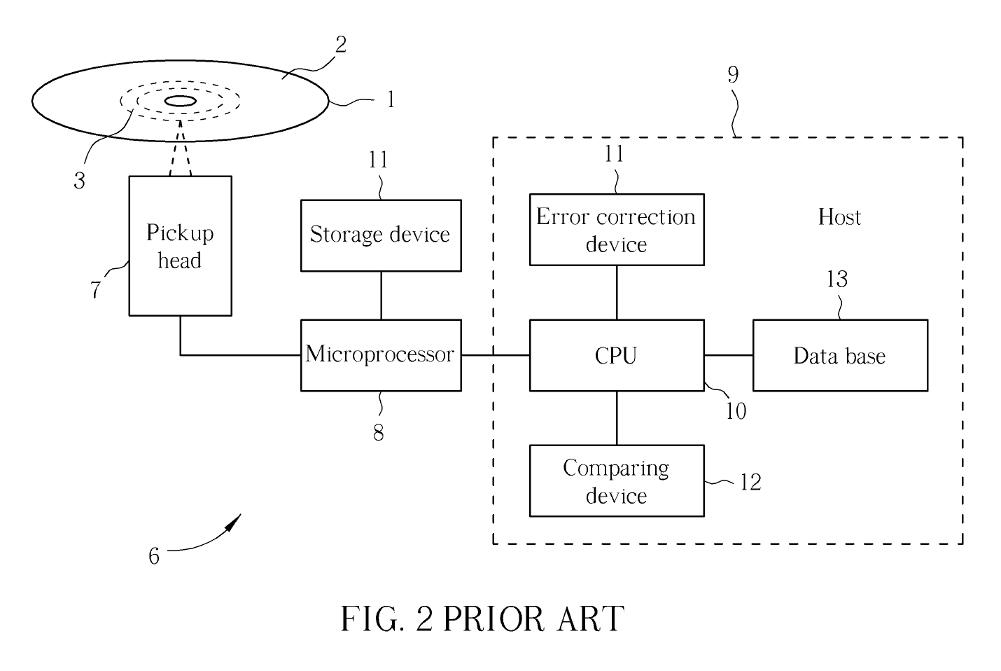

FIG. 3 is a functional block diagram of a light-scribe disc discriminating apparatus according to an embodiment of the present invention.

FIG. 4 is a table of media IDs according to an embodiment of the present invention.

FIG. 5 is a flowchart of light-scribe disc discrimination method according to a first exemplary embodiment of the present invention.

FIG. 6 is a flowchart of light-scribe disc discrimination method according to a second exemplary embodiment of the present invention.

FIG. 7 is a flowchart of light-scribe disc discrimination method according to a third exemplary embodiment of the present invention.

### DETAILED DESCRIPTION

To accomplish the aforementioned objectives, a preferred embodiment of the technique according to the present invention is addressed in conjunction with illustrations in the following paragraphs.

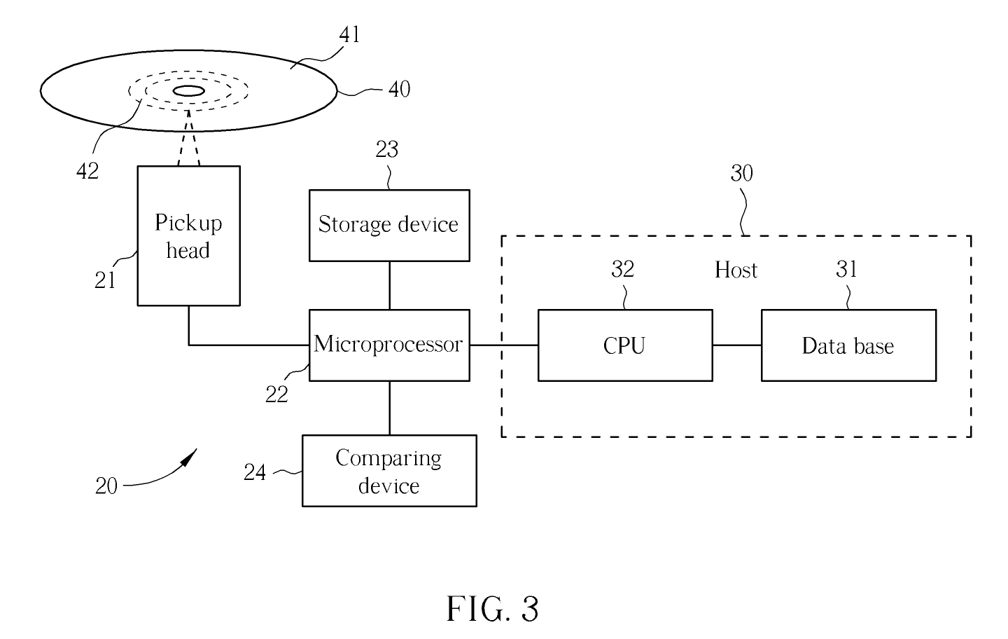

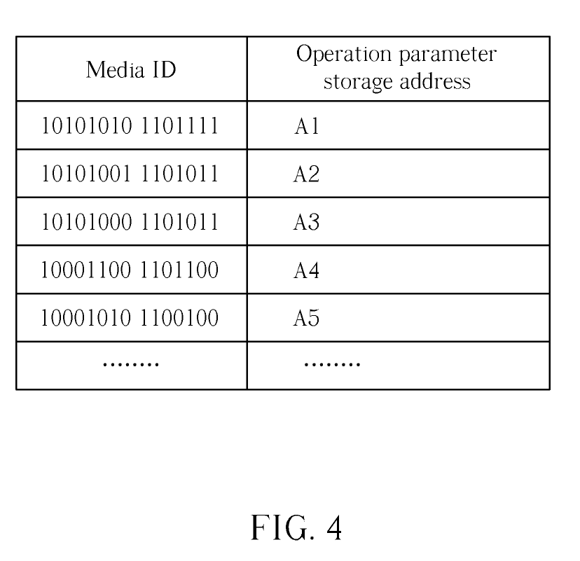

Please refer to FIG. 3 and FIG. 4 simultaneously; FIG. 3 is a light-scribe disc discriminating apparatus 20 according to an embodiment of the present invention, and FIG. 4 is a table of media IDs. As shown in FIG. 3, a light-scribe disc discriminating apparatus 20 is placed in an optical disc drive and connected to a host 30, where the host 30 provides operation parameters of all kinds of media IDs. The light-scribe disc discriminating apparatus 20 includes a pickup head 21, a microprocessor 22, a storage device 23 and a comparing device 24. The pickup head 21 faces the label side 41 of a rotating light-scribe disc 40, and is controlled by the microprocessor 22 to read marks of a media ID in a control feature zone 42 in the inner ring of the label side 41, and therefore a digital signal of the media ID is formed and stored in the storage device 23. The comparing device 24 is controlled by the microprocessor 22 and the media ID is compared with media IDs provided by the host 30, so as to identify a media ID corresponding to the light-scribe disc 40. The operation parameters corresponding to the identified media ID are thereby set as operation parameters of label printing.

The table of media IDs, which is shown in FIG. 4, is generated via testing best operation parameters for printing a label on the label side 41 corresponding to light-scribe discs of media IDs, having operation parameter storage addresses corresponding to the media IDs and stored in a data base 31 in the host 30 since the host 30 has a larger storage capacity. Since the media IDs in the control feature zone 42 of the label side 41 are arranged in a digital bit fashion, the media IDs in the table in the data base 31 are also registered in the digital bit fashion accordingly.

When the light-scribe disc discriminating apparatus 20 follows a user's instruction via the host 30 to perform label printing, the host 30 is controlled by a CPU 32, and the table of media IDs stored in the data base 31 is transmitted to the discriminating apparatus 20 and stored in the storage device 23 via the microprocessor 22. Therefore, the microprocessor 22 can control the comparing device 24 to derive digital signals of the media ID read by the pickup head 21 and the media IDs in the table from the storage device 23. This means the media ID of the light-scribe disc 40 can be identified directly via the bit searching method such as comparing bit by bit or byte by byte.

For most normal control feature zones 42, the pickup head 21 can read the digital signal of media ID correctly. Since the present invention does not require the step of error correction in the prior art, a corresponding media ID in the table can be derived quickly by the comparing device 24, and, via the corresponding address, the host 30 can download corresponding media IDs in the data base 31 and utilize the operation parameters accordingly. For damages such as smears, finger prints or scratches leading to a failure of reading media ID completely by the pickup head 21, a media ID having the most similar bit arrangement is used. For example, typical media ID in the control feature zone 42 has about fifteen marks. Assuming “000000000000000”, those relative locations, which generate high side beam added signals (SBAD) when being read, are changed into “1”, and the others having low SBAD or none SBAD stay the same. If a media ID of a light-scribe disc is read as “10101x10110xx11”, wherein the “x” indicates unreadable, the media ID “101010101101111” can be identified via comparison from the table of media IDs, and, from the operation parameter storage address A1 in the table IDs, the corresponding parameters are downloaded from the data base 31 and are utilized to be set as the operation parameters for label printing. If the read media ID has error bits and cannot be compared, the media ID with least bit comparison error is chosen by the principle of bit arrangement. Although the media IDs are not exactly identical, the more similar the media IDs are, the closer the characteristics of the light-scribe discs will be. Although there will be certain accuracy degradation, e.g. worse figure, color or brightness, the function of label printing can still be performed.

Therefore, the light-scribe disc discriminating apparatus of the present invention can utilize a comparing device in an optical disc drive to read a digital signal of media ID directly, and compare it with media IDs in a table by bits to identify the media ID of the light scribe disc as well as setting operation parameters for label printing accordingly. The digital of the read media ID does not need to be send back to the host for error correction, the objective of simplifying discriminating apparatus is accomplished. In addition, the light-scribe discriminating apparatus can be placed in the optical disc drive according to whether the optical disc drive has the function of light scribing, the light-scribe discriminating apparatus does not need to be placed in all hosts with or without light scribing function, a flexibility of optical disc drive arrangement is achieved and therefore product cost can be lowered.

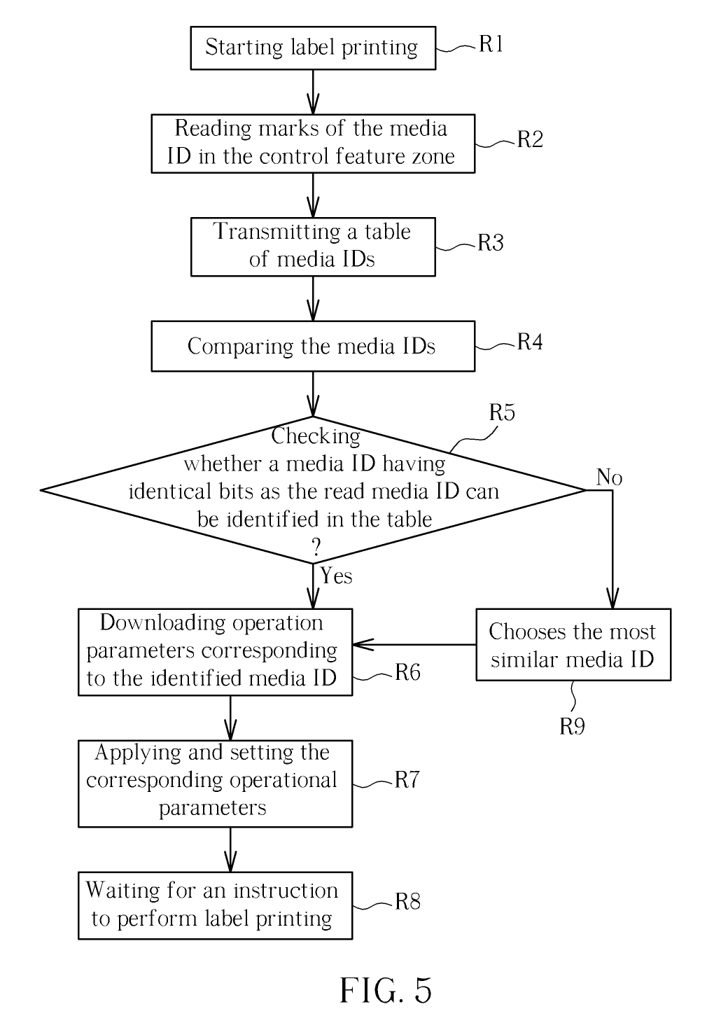

This is shown in FIG. 5, which is a flowchart of light-scribe disc discrimination according to a first exemplary embodiment of the present invention. The steps of comparing directly by bits to identify media ID are as follows: in step R1, a label side of a light-scribe disc is placed towards a pickup head, and label printing is started. In step R2, marks of the media ID in the control feature zone are read to form digital signals. In step R3, a host transmits a table of media IDs stored therein to the comparing device to be stored. In step R4, bits of the read media ID are compared with bits of media IDs in the table one by one, and error quantity of comparison is recorded. In step R5, it is checked whether a media ID having identical bits as the read media ID can be identified in the table. When the media ID having identical bits as the read media ID can be identified in the table, the flow goes to step R6, which performs downloading operation parameters corresponding to the identified media ID via the corresponding storage address in the table. In step R7, the corresponding operational parameters are applied and set according to the identified media ID as printing label operation parameters. In step R8, the flow waits for a user's instruction to perform label printing. And in step R5, when the media ID having identical bits as the read media ID cannot be identified in the table, the flow goes to step R9, which chooses a most similar media ID having a minimum error quantity to be utilized as the identified media ID according to step R4, and then proceeds to step R6, in which operation parameters corresponding to the identified media ID are downloaded via the corresponding storage address in the table. Finally, in step R8, the flow waits for a user's instruction to perform label printing.

Therefore, by utilizing the method of discriminating a light-scribe disc of the present invention, a media ID of a light-scribe disc can be quickly identified via comparing read media ID and media IDs in a table directly. Discrimination efficiency is thereby enhanced. For those media IDs which cannot be identified, a most similar media ID having a minimum comparison error quantity is chosen to be utilized as the identified media ID, and the corresponding operation parameters are applied for label printing. In this way, the objective of avoiding wasting light-scribe discs can be accomplished.

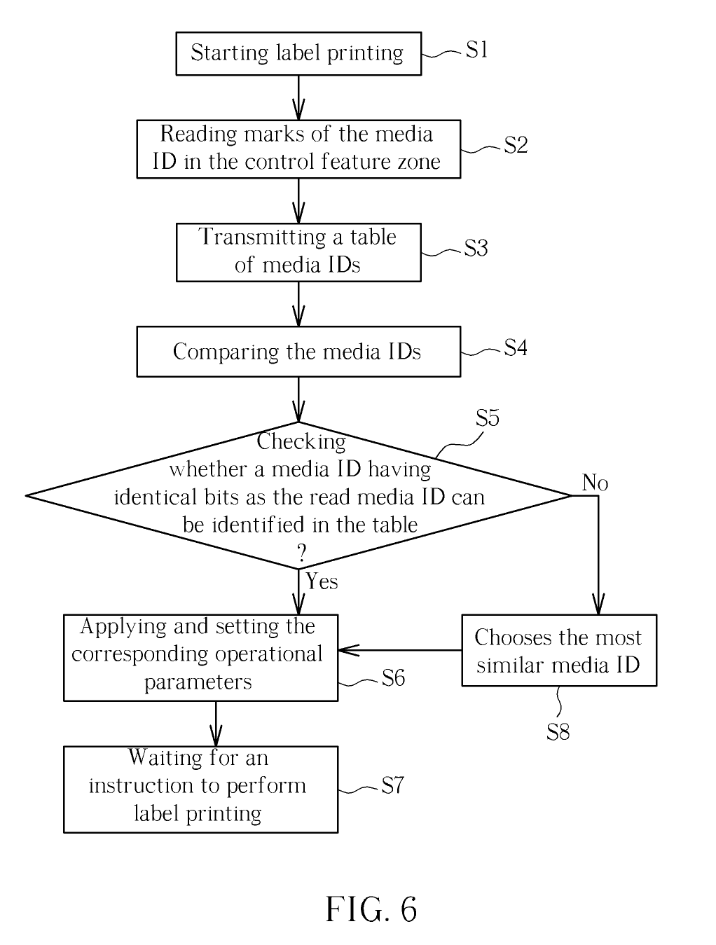

This is shown in FIG. 6, which is a flowchart of light-scribe disc discrimination according to a second exemplary embodiment of the present invention. The steps S1˜S2, S4˜S5 and S6˜S8 in this second embodiment are identical to the steps R1˜R2, R4˜R5 and R7˜R9 in the first embodiment, respectively, and therefore further description is omitted here. The difference between the embodiments is that since the table of media IDs and corresponding operation parameters are stored in the data base of the host in advance, the table of media IDs stored previously must be transmitted to the discriminating apparatus in step R3 for comparison, and therefore need to refer to the storage address to download the corresponding operation parameters. As a result, transmission between the host and the discriminating apparatus must be added in the operation flow. Therefore, the method of the second embodiment downloads the table of media IDs and the corresponding operation parameters to the discriminating apparatus in step S3 for backup, and step R6, downloads the corresponding operation parameters according to the storage address after the media ID is identified. The identifying efficiency is thereby improved.

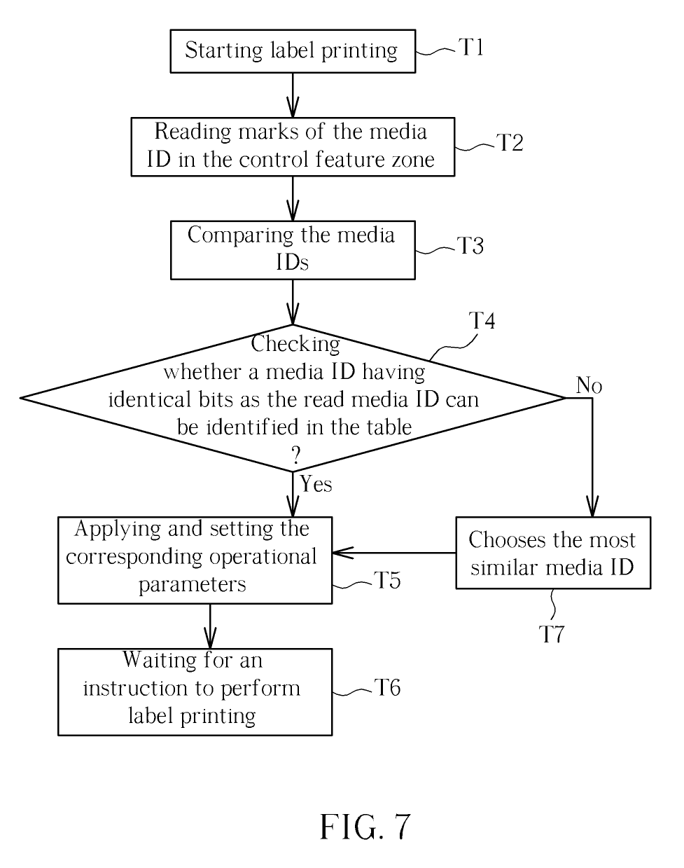

This is shown in FIG. 7, which is a flowchart of light-scribe disc discrimination according to a third exemplary embodiment of the present invention. The steps T1˜T2, T3˜T4 and T5˜T7 in this third embodiment are identical to the steps R1˜R2, R4˜R5 and R7˜R9 in the first embodiment, respectively, and therefore further description is omitted here. The difference between the embodiments is that the third embodiment stores the table of media IDs and the corresponding operation parameters directly in a non-volatile storage device in the discriminating apparatus in advance. Therefore, the third embodiment of the present invention can save steps such as the step R2 of transmitting the table of media IDs and step R6 of downloading the corresponding operation parameters after deriving the media ID in the first embodiment. The identifying efficiency can therefore be improved.

Those skilled in the art will readily observe that numerous modifications and alterations of the device and method may be made while retaining the teachings of the invention.

What is claimed is:

1. A method of discriminating a light-scribe disc, for being applied in a discriminating apparatus coupled to a host to discriminate a media ID of the light-scribe disc, the method comprising:
(1) starting printing a label;
(2) reading the media ID of the light-scribe disc;
(3) transmitting a table of media IDs from the host to the discriminating apparatus;
(4) comparing bits of the read media ID with bits of media IDs in the table;
(5) checking whether a media ID having identical bits as the read media ID can be identified in the table, when the media ID having identical bits as the read media ID can be identified in the table, going to step (7); otherwise, going to step (6);
(6) choosing a media ID having the most similar bits as the read media ID as an identified media ID;
(7) applying and setting corresponding operational parameters according to the identified media ID as printing label operation parameters; and
(8) waiting for a command to print the label for performing printing of the label.

2. The method of claim 1, wherein the table of media IDs is a table, which is generated via testing best operation parameters for printing a label on a label side corresponding to light-scribe discs of media IDs, having operation parameters storage addresses corresponding to the media IDs and is stored in the host in advance.

3. The method of claim 2, wherein in step (7), the operation parameters are downloaded by the host according to the identified media IDs via corresponding storage addresses in the table.

4. The method of claim 1, wherein in step (2), the table of media IDs and the corresponding operation parameters are downloaded in the discriminating apparatus by the host for backup.

5. The method of claim 1, wherein the media IDs in the table are registered in a digital arrangement in accordance with the media ID of the light-scribe disc.

6. The method of claim 1, wherein step (4) comprises:
comparing bits of the read media ID with bits of a media IDs in the table bit by bit.

7. The method of claim 6, wherein step (4) comprises:
recording an error quantity of bit comparison when comparing bits of the read media ID with bits of a media IDs in the table.

8. The method of claim 7, wherein step (6) comprises:
a media ID with the least error quantity is chosen as the media ID having the most similar bits.

9. A method of discriminating a light-scribe disc, for discriminating a media ID of a light-scribe disc and storing a table of media IDs and corresponding operation parameters in a discriminating apparatus, the method comprising:
(1) starting printing a label;
(2) reading the media ID of the light-scribe disc;
(3) comparing bits of the read media ID with bits of media IDs in the table;
(4) checking whether a media ID having identical bits as the read media ID can be identified in the table, when the media ID having identical bits as the read media ID can be identified in the table, going to step (6); otherwise, going to step (5);
(5) choosing a media ID having the most similar bits as the read media ID as a identified media ID;
(6) applying and setting corresponding operational parameters according to the identified media ID as printing label operation parameters; and
(7) waiting for a command to print the label for performing printing of the label.

10. The method of claim 9, wherein the table of media IDs is a table, which is generated via testing best operation parameters for printing a label on a label side corresponding to light-scribe discs of media IDs, having operation parameters storage addresses corresponding to media IDs and is stored in the host.

11. The method of claim 9, wherein step (3) comprises:
comparing bits of the read media ID with bits of a media IDs in the table bit by bit.

12. The method of claim 11, wherein step (3) comprises:
recording an error quantity of bit comparison when comparing bits of the read media ID with bits of a media IDs in the table.

13. The method of claim 12, wherein in step (5), a media ID with the least error quantity is chosen as the media ID having the most similar bits.

14. A light-scribe disc discriminating apparatus, comprising:
a microprocessor, for controlling a pickup head to read a media ID on a label side of a light-scribe disc;
a storage device, coupled to the microprocessor, for storing the read media ID, a table of media IDs and corresponding operation parameters; and
a comparing device, coupled to the microprocessor and the storage device, for being controlled by the microprocessor to derive the read media ID and the table of media IDs to perform bit comparison to verify the media ID of the light-scribe disc;
wherein after the comparing device verifies the media ID of the light-scribe disc, and the microprocessor sets the corresponding operation parameters corresponding to the media ID and stored in the storage device as printing label operation parameters.

15. The light-scribe disc discriminating apparatus of claim 14, wherein the table of media IDs is a table, which is generated via testing best operation parameters for printing a label on a label side corresponding to light-scribe discs of media IDs, having operation parameters storage addresses corresponding to media IDs and is stored for backup.

16. The light-scribe disc discriminating apparatus of claim 15, wherein the light-scribe disc discrimination apparatus is placed in an optical disc drive and connected to a host, and the host has a storage unit for storing the table of media IDs and the corresponding operation parameters for transmitting the table of media IDs and the corresponding operation parameters to the storage device for storage.

17. The light-scribe disc discriminating apparatus of claim 14, wherein the comparing apparatus chooses a media ID having the most similar bits as the media ID of the light-scribe disc.
